(19) United States
(12) Patent Application Publication
(10) Pub. No.: US 2026/0032041 A1
(43) Pub. Date: Jan. 29, 2026

(54) SESSION INITIATION PROTOCOL (SIP) SESSION IN PROGRESS RESPONSE MESSAGE-ORIENTED FILTERING MANAGEMENT

(71) Applicant: T-Mobile USA, Inc., Bellevue, WA (US)

(72) Inventors: Khurram Ahmad Mirza, Bellevue, WA (US); Karthik Chandrasekaran, Bellevue, WA (US); Madhuri Kotta, Bellevue, WA (US)

(21) Appl. No.: 18/784,498

(22) Filed: Jul. 25, 2024

(51) Int. Cl. H04L 41/069; H04L 65/1045; H04L 65/1069; H04L 65/1104

(52) U.S. Cl. CPC H04L 41/069; H04L 65/1045; H04L 65/1069; H04L 65/1104

(57) ABSTRACT

Techniques, devices, and systems for mitigating access failures associated with setting up transmission control protocol (TCP) sessions between user equipment (UEs) and fifth generation (5G) telecommunication networks (or “5G networks”). The 5G networks can include proxy call session control function (P-CSCF) utilized to monitor access failure rates associated with the 5G networks. The P-CSCFs can modify session internet protocol (SIP) messages by extracting provisional responses supported tags from the SIP messages. Triggering and/or performing of the extracting of the provisional responses supported tags can be performed automatically.

### BACKGROUND

An internet protocol multimedia subsystem (IMS) is an architectural framework defined by the 3rd generation partnership project (3GPP) for delivering internet protocol (IP) multimedia to user equipment (UEs) of the IMS network. During a registration procedure for IMS-based services, a UE is assigned a proxy call session control function (P-CSCF). The P-CSCF acts as an ingress and egress point to and from the IMS core with respect to the UE, once registered.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is an illustrative environment depicting an IMS core with a P-CSCF that has a session in progress communication-oriented filtering module for a UE exchanging one or more transmission control protocol (TCP) session setup-oriented session internet protocol (SIP) communications.

FIG. 2 shows an example call flow illustrating session in progress communication-oriented filtering management utilizing a P-CSCF for a UE exchanging one or more TCP session setup-oriented SIP communications.

FIG. 3 shows an example call flow illustrating session in progress communication-oriented filtering management utilizing a P-CSCF to insert a tag in a success communication.

FIG. 4 illustrates an example process for session in progress communication-oriented filtering management.

FIG. 5 illustrates is a block diagram of a server computer architecture, in accordance with some examples of the present disclosure.

### DETAILED DESCRIPTION

This disclosure is directed in part to mitigating access failures associated with setting up TCP sessions between UEs and fifth generation (5G) telecommunication networks (or “5G networks”). The 5G networks can include P-CSCFs utilized to monitor access failure rates associated with the 5G networks. The P-CSCFs can manage call session messages based on the access failure rates exceeding thresholds. The call session messages, such as SIP messages, can be modified before and/or during fallback operations of UEs from the 5G network to a non-5G network. Modifying the SIP messages can include temporarily postponing unnecessary signaling. The unnecessary signaling can be temporarily postponed by extracting provisional responses supported tags from the SIP messages, such as session in progress messages being transmitted to UEs. Extracting the provisional responses supported tags enables the UEs to temporarily refrain from utilizing exchanges of SIP messages, such as provisional acknowledgment and/or acknowledgement messages.

Accordingly, the techniques, devices, and systems described herein improve the success rates of telecommunication networks, including 5G networks, and/or networks of other kinds. UEs connected to existing networks may, at relatively high rates with respect to numbers of UEs that experience dropped calls, ring, beep, and then end the call; or have dead air and then beep and end the call. In contrast to those networks operating according to existing technology, which may experience relatively low success rates for UEs (e.g., UEs for which TCP-based call sessions are being setup, and for which fallbacks to non-5G networks are being performed due to the UEs being unable to operate utilizing 5G (e.g., 5G new radio (NR)), networks operated utilizing the current techniques improve success rates by performing automated filtering of tags in SIP messages that enable UEs to complete setups for TCP-based sessions as well as fallbacks to non-5G networks. The setups and fallbacks can be successfully performed and completed with higher reliability. For example, the tags may include 100RELs in 183 SIP messages that may be moved to 180 SIP messages so that fallbacks for the UEs, as well as the TCP-base session setups, may be performed successfully.

Automated filtering can be automatically performed based on identifying that access failure rates exceed a predetermined threshold, such as by performing machine learning (ML) analysis of the network related data, including the access failure rates. In contrast to networks managed according to existing technology that require relatively slow, laborious, time intensive, and unreliable human-driven network management and adjustment of SIP messages to reduce failure rates for cases in which success rates fall, the networks managed according to techniques discussed herein leverage automated techniques to resolve issues relatively quickly, effectively, easily, reliably, and inexpensively, thereby improving network success rates, overall network performance, and UE operation.

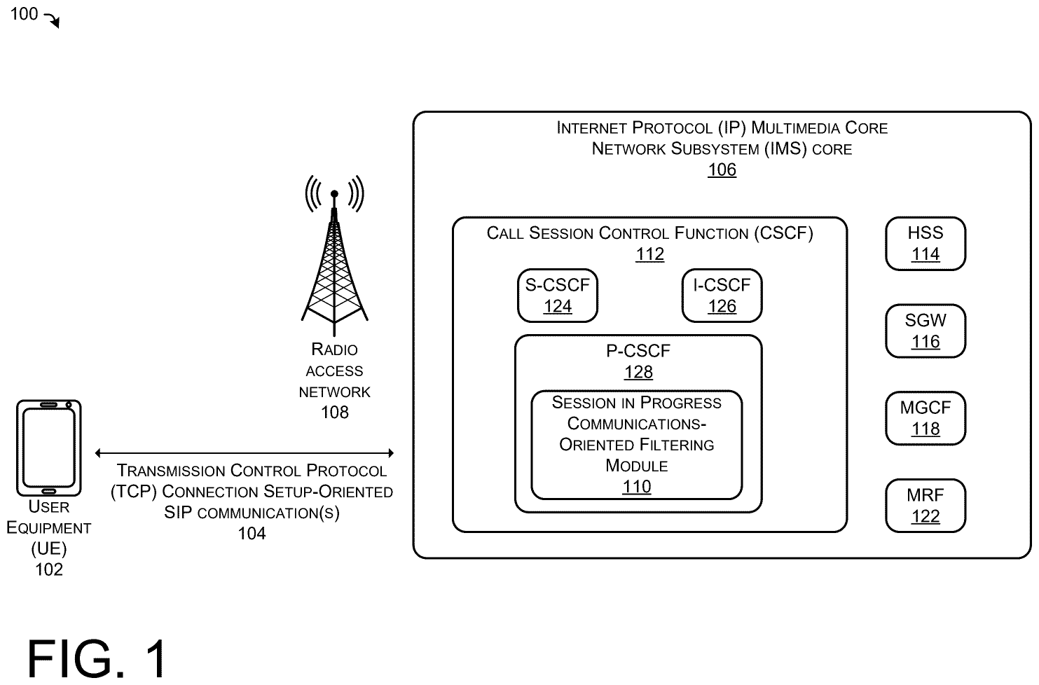

FIG. 1 is an illustrative environment 100 depicting an IMS core with a P-CSCF that has a session in progress communication-oriented filtering module for a UE exchanging one or more TCP session setup-based SIP communications. In some implementations, the environment 100 can include one or more UEs, such as a UE 102, exchanging one or more messages (or “communication(s)”) (e.g., one or more SIP communications) 104. For example, the SIP communication(s) (e.g., one or more TCP session setup-oriented SIP communications) 104 may be exchanged between the UE 102 and the IMS core (or “core”), such as an IMS core 106, of an IMS of a telecommunications network (or “network”), via a radio access network 108. The SIP communication(s) may be exchanged to set up, and/or establish, one or more sessions between the UE(s), such as the UE 102, and one or more networks (e.g., the telecommunication network, which may be a 5G network).

For example, the session may include communications paths via at least one telecommunications network for exchange of data among two or more computing devices (e.g., the UE(s), such as the UE 102), also referred to herein as terminals. Example sessions, which may be setup via one or more TCP connections established with the UE 102 via the 5G network, may include voice and/or video calls, e.g., by which human beings converse, data communication sessions, e.g., between two electronic systems or between an electronic system and a human being, rich communication services (RCS) sessions, and so on, or any combination thereof.

In some examples, the UE 102 may be compatible with a non-5G network, such as a long term evolution (LTE) network, but not the 5G network. The UE 102 not being compatible with the 5G network may include the UE 102 not being compatible with 5G NR.

The P-CSCF (e.g., the P-CSCF 128, as discussed below in further detail) can include one or more modules, such as a session in progress communications-oriented filtering module (or “filtering module”) 110, to perform any combination of one or more various functions utilized for operation of the P-CSCF 128. For example, the filtering module 110 can utilize access failure rates (or “drop call rates”) to identify whether to extract provisional responses supported text (e.g., provisional responses supported American Standard Code for Information Interchange (ASCII) text and/or bytes). In such an example or another example, the provisional responses supported text may include provisional responses supported tags (e.g., 100REL tags) from session in progress communications (e.g., SIP 183 messages). Filtering performed by the filtering module 110 may improve access failure rates associated with the network(s) (e.g., the 5G network and/or one or more other non-5G networks), such as in cases in which the UE(s), such as the UE 102, are performing fallback procedures from the 5G network to a non-5G network, such as an LTE network, etc. (e.g., based on the UE 102 not being compatible with the 5G NR). The filtering may enable the UE(s) to exchange, during setup of one or more TCP sessions, signaling required for the fallback(s), without being delayed by waiting for provisional acknowledgment(s)/acknowledgement(s) triggered by (e.g., and/or indicated as being supported via) the 100REL tags in the SIP 183 messages.

In some examples, the UE 102 not being triggered by the provisional responses supported tag (e.g., a current tag), refrains from transmitting a provisional acknowledgement SIP message (or “provisional acknowledgement message”) and waiting until an acknowledgment SIP message (or “acknowledgement message”) is received as the UE is being redirected to a non-5G network. In those or other examples, such as at a previous time, the P-CSCF 128 may receive a previous SIP invite message associated with a previous SIP session. The P-CSCF 128 may forward, to the UE 102, the previous invite SIP message with a previous provisional responses supported tag. For instance, the P-CSCF 128 may forward, to the UE 102, the previous invite SIP message with the previous provisional responses supported tag. The previous invite SIP message with the previous provisional responses supported tag may trigger the UE 102 to transmit a provisional acknowledgement SIP message and wait until an acknowledgement SIP message is received.

In various implementations, one or more modules of the P-CSCF 128, such as the filtering module 110, can include one or more ML models utilized to mitigate access failures (or “dropped calls”) of the 5G network. By way of example, the filtering module 110 can input access failure rates (e.g., rates being generated by, and/or received from, one or more nodes and/or one or more servers of the 5G network, and/or one or more other computing devices), and/or data associated therewith (e.g., data being generated by, and/or received from, the node(s) and/or the server(s) of the 5G network, and/or the other computing device(s)), to the ML model(s). The access failure rates, and/or the access failure rates data (e.g., data including the access failure rates and/or other related data associated therewith), may be associated with the 5G network. For instance, the filtering module 110 can analyze, via the ML model(s), the access failure rates and utilize output of the ML model(s) to identify whether to filter data in session in the progress SIP communications. In such an instance or another instance, the filtering module 110 can mitigate the access failures based on the filtering of the session in progress SIP communications data.

In various implementations, the filtering module 110 can utilize a comparison performed between a parameter associated with the access failure rates and a threshold to identify whether to filter data in the session in progress SIP communications. For example, the filtering module 110 can utilize the ML model(s) to analyze the access failure rates to generate the parameter, and to output data (e.g., a flag) indicating whether to filter session in progress SIP communications data. The data (e.g., the flag being set) indicating to filter session in progress SIP communications data can be utilized by the filtering module 110 to filter the progress SIP communications data. The data (e.g., the flag not being set) indicating not to filter session in progress SIP communications data may be utilized by the filtering module 110 to refrain from filtering the progress SIP communications data.

In some cases, the filtering model 110 can filter session in progress SIP communications data of a session in progress SIP communication (e.g., a SIP 183 message) associated with the UE 102 by removing a provisional responses supported tag (e.g., the 100REL) from the session in progress SIP communication. The filtering model 110 can remove the provisional responses supported tag from the session in progress SIP communication based on ML model output indicating to filter the session in progress SIP communication.

Triggering and/or performing of the filtering (e.g., the extracting of the provisional responses supported tags) can be performed automatically. The automated triggering and/or performing can be performed based on the ML model output. The filtering (e.g., the extracting) can be performed before and/or during fallback operations performed for the UE 102. Filtering can be performed for TCP-based session setup for any number of UEs that are similar to the UE 102 (e.g., UEs that are not compatible with 5G NR and for which fallbacks are possibly being performed).

Filtering session in progress SIP communications may result in fewer dropped calls. Numbers of dropped calls may decrease by the filtering of the session in progress SIP communications because the UEs are enabled to fallback to non-5G networks, without call setup being delayed by the UEs trying to transmit provisional acknowledgements and/or wait for acknowledgements. The UEs refrain from trying to transmit provisional acknowledgements and/or waiting for acknowledgements, since the provisional responses supported tags (e.g., otherwise utilized to instruct the UEs to try to transmit provisional acknowledgements and/or wait for acknowledgements) are omitted from the session in progress SIP communications received by the UEs.

The access failure rates include various types of rates. For example, the access failure rates include an answer-seizure ratio (ASR). The ASR can include a measurement (e.g., parameter) of network quality and call success rates in the 5G network. The ASR can include a percentage of answered telephone calls with respect to a total call volume of a portion (e.g., a partial portion or an entire portion) of the 5G network. For example, the access failure rate parameter may include a percentage of answered telephone calls with respect to a total call volume of the 5G network and/or one or more non-5G networks (e.g., the LTE network). In some instances, an attempted call is termed a seizure. The ASR may be defined as 100 times a ratio of answered calls (e.g., a number of seizures resulting in an answer signal) divided by a total number of seizures. In some examples, an attempted call that is not answered, such as an attempted call resulting in a busy signal, an attempted call that is incomplete, or any other types of call rejections by a telephone network, is termed a call failure.

Although the ASR may be partially based on the ratio of answered calls, as discussed above in the current disclosure, it is not limited as such. In some examples, a ratio of answered calls on which the ASR is partially based may include the other access failure rates related data, which can include data identifying one or more of various types of incomplete calls. The incomplete calls related data in the other access failure rates related data may include data identifying various types of incomplete calls, which may be highly dependent on end-user action, such as incomplete calls as a result of far-end switch congestion, called parties not answering, destination circuits that are busy, and the like, or any combination thereof. Whether to use any of the type of incomplete calls may be based on analysis by the ML model(s) of the other access failure rates related data.

Although the access failure rates can be utilized to mitigate the access failures, as discussed above in the current disclosure, it is not limited as such. In some examples, success rates may be utilized to mitigate the access failures in a similar way as the access failure rates.

Although the ML model(s) can be utilized to analyze the access failure rates data, as discussed above in the current disclosure, it is not limited as such. In some examples, any of one or more types of models, which can possibly include any of the ML model(s), can be utilized in a similar way as the ML model(s) for purposes of implementing any of the techniques as discussed throughout the current disclosure. In those or other examples, the model(s) include one or more models of various types, which can include one or more data algorithm models of various types, one or more artificial intelligence (AI) models of various types, one or more other models, or any combination thereof. In those or other examples, any of the ML models of various types can be, and/or include, any of the ML model(s) and/or one or more models of other types.

Although various types of model(s) (e.g., the ML and/or AI model(s) can be utilized to analyze the access failure rates data, as discussed above in the current disclosure, it is not limited as such. In some examples, the model(s) can include one or more ML models that are unsupervised and/or one or more ML models that are supervised. For instance, with examples including the unsupervised ML model(s), the model(s) can include one or more principal component analysis (PCA) ML models, one or more K-means clustering ML models, one or more mean shift algorithm ML models, one or more density-based spatial clustering of applications with noise (DBSPCAN) ML models, one or more k-nearest neighbors (KNN) ML models, one or more hierarchal clustering ML models, one or more anomaly detection ML models, one or more neural networks ML models, one or more independent component analysis ML models, one or more apriori algorithm ML models, one or more other types of unsupervised ML models, or any combination thereof. Alternatively or additionally, with examples including the supervised ML model(s), the model(s) can include one or more random forest algorithm ML models, one or more decision tree algorithm ML models, one or more logistic regression algorithm ML models, one or more support vector machine algorithm ML models, one or more other types of supervised ML models of various types, or any combination thereof.

In those or other examples, the model(s) (e.g., the ML model(s)) can include one or more large language models (e.g., the ML model(s) can include various types of ML models, including the large language models). For instance, the large language model(s) can be utilized for analyzing of the access failure rates data. In various cases, the large language model(s), alternatively or additionally to one or more other models (e.g., any of the model(s), as discussed herein), can be utilized to identify the one or more classification(s) of the access failure rates data and synthesize network management data and/or information provided to the model in combination with the access failure rates data to generate access failure rates data analysis.

In various implementations, one or more ML models (e.g., one or more untrained and/or partially trained ML models) may be trained to be the ML model(s) (e.g., the trained ML model(s)), as discussed throughout the current disclosure. Training may include inputting, into the ML model(s), data (e.g., historical data), which may be similar to, or different from, the any of the data input to the ML model(s). Any of the data input to, and/or available to be input to, the ML model(s), as discussed through the current disclosure, for purposes of performing filtering management (e.g., for purposes of operating the filtering module 110 and/or the P-CSCF 128) may, alternatively or additionally, be utilized to train the ML model(s).

The IMS core 106 can include one or more nodes. For examples, the node(s) of the IMS core 106 can include a CSCF 112, a home subscriber server (HSS) 114, a signaling gateway (SGW) 116, a media gateway control function (MGCF) 118, a media resource function (MRF), one or more other nodes, or any combination thereof. The CSCF 112 can be utilized to control sessions between applications, endpoints, and/or terminals, such as the UE 102, the HSS 114, the SGW 116, the MGCF 118, the MRF 122, and/or the other node(s).

The node(s) can be utilized by the IMS core 106 in various ways. The HSS 114 can maintain a master database for all user profile information used to authenticate and authorize subscribers. The SGW 116 and The MGCF 118 can provide interoperability with a public switched telephone network (PSTN), such as for connecting the UE 102 to the PSTN. The MRF 122 can provide media-related functions.

The CSCF 112 can include one or more nodes, such as, for example, a serving-CSCF (S-CSCF) 124, an interrogating-CSCF (I-CSCF) 126, and a P-CSCF 128. The CSCF 112 can be utilized to manage call sessions for the UE 102 in various ways. For example, network (e.g., the 5G network, the 4G network, etc., or any combination thereof) can receive a request from the UE 102 to connect to a particular service. The UE may be attempting to place a voice call, for example, or connecting to a video streaming service. The request can be received by a network entity such as, for example, the S-CSCF 124 or the P-CSCF 128, which can then route the UE 102 to one or more application servers (ASs).

The S-CSCF 124 can be utilized by the IMS core 106 in various ways. The S-CSCF 124 can handle SIP registrations, which allows the S-CSCF 124 to bind a user location (e.g., an IP address of the UE 102) and a SIP address. The S-CSCF 124 can sit on a path of signaling messages of locally registered UEs, such as the UE 102, and inspect the signaling messages. For example, the S-CSCF 124 can apply filtering criteria to determine that a SIP invite message should be forwarded to an AS, which may be utilized provide services for the UE 102 via the radio access network 108.

The I-CSCF 126 can be utilized by the IMS core 106 in various ways. The I-CSCF 126 can act as an inbound SIP proxy server in the IMS core 106. During IMS registrations, the I-CSCF 126 can query the HSS 114 to select the appropriate S-CSCF 124. During IMS sessions, the I-CSCF 126 can act as an entry point to terminating session requests. The I-CSCF 126 can query the HSS 114 to retrieve an address of the S-CSCF 124 and assign the S-CSCF 124 to a user performing SIP registration. I-CSCF 126 can route incoming session requests or responses to the S-CSCF 124.

The P-CSCF 128 can be utilized by the IMS core 106 in various ways. The P-CSCF 128 can be in a home domain of an IMS operator of the IMS core 106 (e.g., or the P-CSCF 128 can represent a P-CSCF in a visiting domain, where the UE 102 is currently roaming). For attachment to the P-CSCF 128, the P-CSCF 128 can be utilized by the UE 102 performing P-CSCF discovery procedures. Attachment to the P-CSCF 128 enables the UE 102 to initiate registrations and sessions with the IMS core 106. The P-CSCF 128 can be utilized to protect the network, and also the UE 102.

As used herein, the term “module,” and its equivalents, refers to data including instructions that, when executed by one or more processors, cause the processor(s) to perform one or more operations. In some cases, the P-CSCF 128 (e.g., one or more computing devices associated therewith) includes the processor(s), and a memory that stores files, databases, or a combination thereof. For example, the P-CSCF 128 can manage (e.g., identify, determine, obtain, receive, generate, delete, modify, analyze, replace, divide, collate, distribute, etc., or any combination thereof) various types of data, such as data associated with access failures during operation of the P-CSCF 128. This and other data may be stored, at least temporarily, in the memory. In some examples, the memory can include RAM, ROM, electrically erasable programmable read-only memory (EEPROM), flash memory, or any other memory technology. In some examples, the memory includes CD-ROMs, digital versatile discs (DVDs), content-addressable memory (CAM), and/or other optical storage, magnetic cassettes, magnetic tape, magnetic disk storage and/or other magnetic storage devices, and/or any other medium (e.g., non-transitory computer-readable medium) which can be used to store the desired information and which can be accessed by the processor(s).

Although the network to which the UE 102 is establishing a session with can include the 5G network, as discussed above in the current disclosure, it is not limited as such. In some examples, the network can represent one or more of any type of network (e.g., the 5G network, a fourth generation (4G) (e.g., an LTE-advanced (LTE-A) network, an LTE network, etc.), a third generation (3G) network, etc., or any combination thereof).

Although the UE 102 may be a UE that is not compatible with 5G (e.g., 5G NR) as discussed above in the current disclosure, it is not listed as such. For example, the filtering, and benefits thereof, may be applicable to the UE 102 representing any UE that is not compatible with 5G, not compatible with 5G NR not able to connect to a 5G network and/or 5G NR for any reason, not able to utilize voice over new radio (VoNR), not VoNR whitelisted, and so on, or any combination thereof.

Although filtering can be performed for UEs that are not compatible with 5G NR and for which fallbacks are possibly being performed, as discussed above in the current disclosure, it is not limited as such. In some examples, filtering can, alternatively or additionally, be performed for UEs for which fallbacks are not currently being performed. In alternative or additional examples, filtering can be performed possibly for UEs for which fallbacks are not going to be performed. In alternative or additional examples, the filtering can be even performed for any types of UEs (e.g., UEs that are compatible with any type of network, such as 5G networks) (e.g., UEs that are compatible with 5G NR).

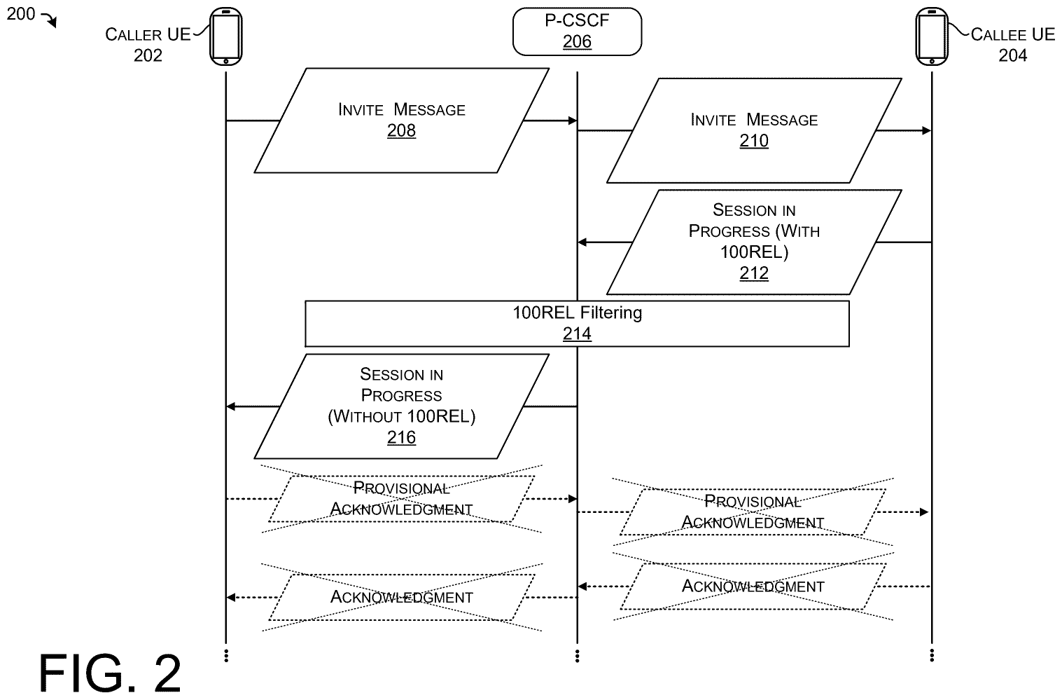

FIG. 2 shows an example call flow 200 illustrating session in progress communication-oriented filtering management utilizing a P-CSCF for a UE exchanging one or more TCP session setup-oriented SIP communications. In various examples, a UE 202, such as a caller (e.g., UE attempting to place a call), may exchange one or more communications (e.g., SIP communications) with a UE 204, such as a callee (e.g., a UE to which the attempted call is being placed). For instance, the UE 202 does not have one or more capabilities which would enable the UE 202 to operate utilizing a 5G network, which includes a P-CSCF 206. In some examples, the UE(s) 202 and/or 204 may be utilized to implement the UE 102, as discussed above with reference to FIG. 1. In those or other examples, the P-CSCF 206 may be utilized to implement the P-CSCF 128, as discussed above with reference to FIG. 1.

An invite message (e.g., a SIP invite message) 208 can be exchanged between the UE 202, which is attempting to place a call, and the P-CSCF 206. The invite message 208 can be generated by the UE 202. The UE 202 may transmit the invite message 208 to the P-CSCF 206. Transmitting of the invite message 208 by the UE 202 can be performed by the UE 202 to set up a TCP-based session via a 5G network. For example, transmitting of the invite message 208 may be part of, and/or utilized to initiate, the TCP session.

The invite message 208 can be forwarded by the P-CSCF 206, as the invite message 210, to the UE 204. For example, the P-CSCF 206 can receive the invite message 208, and route the invite message 208 as the invite message 210. The P-CSCF 206 can route (e.g., transmit) the invite message 210 to the UE 204. The invite message 210 may be transmitted by the P-CSCF 206 and received by the UE 204, as part of the setup of the TCP session. In some examples, the invite message 210 may represent the same invite message being transmitted, as the invite message 208, by the UE 202. Alternatively, the invite message 210 being generated by the P-CSCF 206 may be different from, and/or transmitted based on, the invite message 208.

The UE 204 can receive the invite message 210 and generate a session in progress message 212. For instance, the session in progress message 212 may be a SIP 183 message. In some examples, the session in progress message 212 may include a provisional responses supported tag. For instance, the provisional responses supported tag may be 100REL text (e.g., 100REL ASCII text and/or bytes), such as a 100REL tag (or “100REL”).

The P-CSCF 206 can perform filtering (e.g., session in progress-oriented filtering) 214 based on the session in progress message 212. In some examples, the P-CSCF 206 can receive the session in progress message 212 and perform the filtering (e.g., 100REL tag filtering) (or “100REL filtering”) 214. The 100REL tag filtering can include, for instance, extracting (e.g., removing) the 100REL from the session in progress message 212. In some examples, the 100REL is extracted from a header of the session in progress message 212.

In some examples, the analyzing of the parameter and the filtering of the 100REL can be performed automatically based on determining the parameter associated with the access failure rates is above the threshold. For instance, in response to performing the ML model analysis and determining the parameter is above the threshold, filtering can be triggered. In response to the triggering of the filtering, the P-CSCF 206 can manage the extracting (e.g., removing) of the 100REL from the session in progress message (e.g., the SIP 183 message) 212 via automated 100REL filtering operations performed by the P-CSCF 206. In other words, the triggering of the filtering (e.g., which includes performing the ML model analysis, receiving the ML model output, and triggering the filtering) and the extracting of the 100REL can be automated. Relocating of the 100REL into one or more other portions of the TCP-based setup, such as in the 180 ringing SIP messages, as discussed below in further detail, can be automated, additionally or alternatively, to automation of the 100REL extraction/filtering during fallback procedures. In some examples, the fallbacks represent various types of procedures, such as handovers.

A termination point of the filtering and/or relocation of the 100REL can be automated (e.g., managed automatically). The 100REL extraction/filtering and/or the relocating of the 100REL can be suspended to return operation as performed prior to the filtering. The resuming of the returning to operation as performed prior to the filtering can be performed based on ML model analysis in a similar way as for the ML model analysis utilized to determine to filter/relocate the 100REL. For example, the returning to operation as previously performed prior to the filtering can be performed based on output of the ML model analysis indicating that access failure rates fall below a threshold (e.g., the same threshold utilized to trigger the 100REL filtering/relocating or a different threshold).

A session in progress message (e.g., a SIP session in progress message) 216 can be exchanged between the P-CSCF 206 and the UE 202. The session in progress message 216 may omit the provisional responses supported tag. The session in progress message 216 can be generated by the P-CSCF 206. The P-CSCF 206 may transmit the session in progress message 216 to the UE 202. Transmitting of the session in progress message 216 by the P-CSCF 206 can be performed by the P-CSCF 206 as part of the setup of the TCP-based session for the UE 202 via the 5G network. For example, transmitting of the session in progress message 216 may be part of, and/or utilized to continue setup of, the TCP session.

The session in progress message 212 with the provisional responses supported tag can be forwarded by the P-CSCF 206, as the session in progress message 216 except without the provisional responses supported tag, to the UE 202. For example, the P-CSCF 206 can receive the session in progress message 212, and route the session in progress message 212 (e.g., without the provisional responses supported tag) as the session in progress message 216. In some examples, the session in progress message 216 may represent the same session in progress message being transmitted without the provisional responses supported tag as the session in progress message 216, by the P-CSCF 206. Alternatively, the session in progress message 216 being generated by the P-CSCF 206 may be different from, and/or transmitted based on, the invite session in progress message 212, with the session in progress message 216 omitting the provisional responses supported tag.

By refraining from transmitting the session in progress 212 with the 100REL, and instead transmitting the session in progress 216, with the 100REL, the P-CSCF 206 can enable the UE 202 to continue with the session setup without delays that may otherwise occur according to conventional technology. In contrast to existing systems in which TCP session setup for UEs my experience delays due to the UEs transmitting, in response to receiving session in progress messages (e.g., SIP 183 messages) during setup of TCP sessions, provisional acknowledgement messages and/or waiting for acknowledgment messages while the UEs are performing fallback procedures to connect to non-5G networks, the UE 202 operating according to techniques discussed herein does not experience such delays.

For example, as represented by crossed out communications illustrated in FIG. 2, the UE 202 may refrain from transmitting, in response to receiving the session in progress message (e.g., SIP 183 message) 216 during setup of TCP session, a provisional acknowledgement message and/or refraining from waiting for an acknowledgment message while the UE 102 is performing a fallback procedure to connect to a non-5G network. In contrast to dropped calls that may occur for the UEs operating according to conventional technology, a likelihood of a dropped call for the UE 202 may be reduced and/or eliminated. The likelihood of a dropped call for the UE 202 may be reduced and/or eliminated for the UE 202 because of the UE 202, in response to receiving the session in progress message (e.g., SIP 183 message) 216 (e.g., without the 100REL) during setup of TCP session, refraining from transmitting the provisional acknowledgement message and/or refraining from waiting for the acknowledgment message.

A portion of communications associated with a reliable transmission protocol (e.g., the TCP), which includes the provisional acknowledgment message(s) and/or the acknowledgment message(s), may be temporarily converted to unreliable transmission protocol-related communications. For example, according to the reliable transmission protocol, the provisional acknowledgment message(s) and/or the acknowledgment message(s) are exchanged (e.g., transmitted and/or received). Alternatively, according to the temporary conversion from using the reliable transmission protocol to using the unreliable transmission protocol, the provisional acknowledgment message(s) and/or the acknowledgment message(s) are not exchanged (e.g., transmitted and/or received).

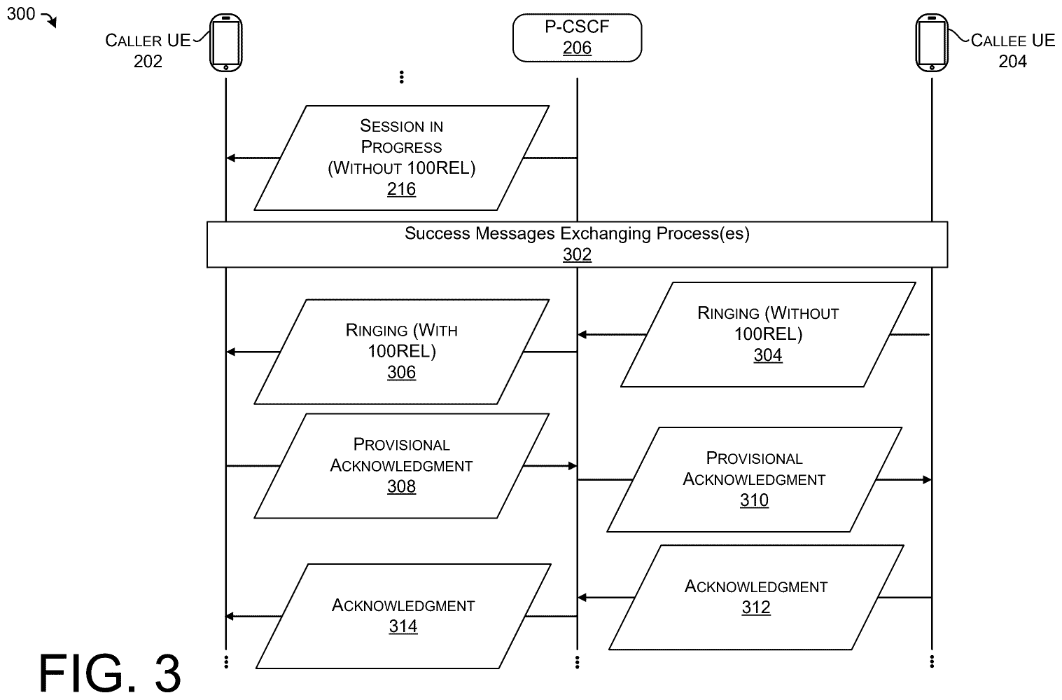

FIG. 3 shows an example call flow 300 illustrating session in progress communication-oriented filtering management utilizing a P-CSCF to insert a tag in a success communication. For example, the call flow 300 can include a portion (e.g., a partial portion or an entire portion) of the call flow 200 performed by the UE(s) 202 and/or 204, and/or the P-CSCF 206, as discussed above with reference to FIG. 2. In such an example or another example, the call flow 300 can include exchanging of one or more of the communication(s), including the invite message(s) 208 and/or 210, the session in progress message(s) 212 and/or 216, and/or include performing of the 100REL filtering 214, as discussed above with reference to FIG. 2.

In some implementations, one or more success status communications (or “success message(s)”) can be exchanged based on the session in progress 216 being exchanged between the UE 202 and the P-CSCF 206. By way of example, one or more success messages exchanging processes 302 can be performed utilizing the UE(s) 202 and/or 204, and/or the P-CSCF 206. For instance, individual ones of the success messages exchanging process(es) 302 being performed can include the UE 202 transmitting a success message to the P-CSCF 206, the P-CSCF 206 transmitting a success message to the UE 204, UE 204 transmitting a success message to the P-CSCF 206, and/or the P-CSCF 206 transmitting a success message to the UE 202. In various examples, any of the success message(s) being received by the P-CSCF 206 can be routed by the P-CSCF 206 to the UE(s) 202 or 204 as the same message, or utilized by the P-CSCF 206 to transmit a different message to the UE(s) 202 or 204.

According to the call flow 300, the UE 204 can transmit a ringing status communication (or “ringing message”) 304. In some examples, the ringing message 304, such as a SIP 180 message, may not include any 100REL. In those or other examples, the UE 204 generating the ringing message 304 the omit the 100REL from the ringing message 304. For instance, the ringing message 304 may be transmitted without any 100REL.

In some implementations, the P-CSCF 206 may insert, in a ringing message received from the UE 204, a provisional responses supported tag (e.g., 100REL tag). For instance, the ringing message 304 received from the UE 204, and into which the provisional responses supported tag is inserted, may be routed as the ringing message 306. The ringing message 306 may be routed by the P-CSCF 206 and to the UE 202. The provisional responses supported tag inserted into the ringing message 306 may be the same type as (e.g., include the same text as), or a different type from (e.g., include different text from), the provisional responses supported tag extracted from the session in progress 212. For example, the provisional responses supported tag inserted into the ringing message 306 may be the same provisional responses supported tag extracted from the session in progress 212. As an alternative example, the provisional responses supported tag inserted into the ringing message 306 may be a different provisional responses supported tag from the provisional responses supported tag extracted from the session in progress 212.

In various cases, the UE 202, in response to receiving the ringing message 306 with the provisional responses supported tag, can identify the provisional responses supported tag is included in the ringing message 306. In response to the identifying of the provisional responses supported tag in the ringing message 306, the UE 202 can transmit provisional acknowledgements and/or wait for acknowledgements.

The transmitting of the provisional acknowledgements and/or waiting for acknowledgements can include transmitting of various provisional acknowledgements. For example, the transmitting of the provisional acknowledgements can include the UE 202 transmitting a provisional acknowledgement communication 308 to the P-CSCF 206.

In the example or another example, the transmitting of the provisional acknowledgements can include the P-CSCF 206 routing the provisional acknowledgement communication 308 as the provisional acknowledgement communication 310 to the UE 204 (e.g., or the P-CSCF 206 generating and transmitting the provisional acknowledgement communication 310 to the UE 204, based on the provisional acknowledgement communication 308).

The transmitting of the provisional acknowledgements and/or waiting for acknowledgements can include waiting for various acknowledgements. By way of example, the waiting for the acknowledgements can include the UE 204 transmitting an acknowledgement communication 312 to the P-CSCF 206, based on the provisional acknowledgement communication 310. In the example or another example, the transmitting of the acknowledgements can include the P-CSCF 206 routing the acknowledgement communication 312 as the acknowledgement communication 314 to the UE 202 (e.g., or the P-CSCF 206 generating and transmitting the acknowledgement communication 314 to the UE 202, based on the acknowledgement communication 312).

The provisional acknowledgement(s) 308 and/or 310 and/or the acknowledgement(s) 312 and/or 314 can be utilized as part of the TCP-based session. The provisional acknowledgement(s) 308 and/or 310 and/or the acknowledgement(s) 312 and/or 314 can be the same as, or different from, provisional acknowledgement(s) (e.g., hypothetical provisional acknowledgement(s)) and/or acknowledgement(s) (e.g., hypothetical acknowledgement(s)) that would have been exchanged previously had the 100REL not been missing from the session in progress message 216.

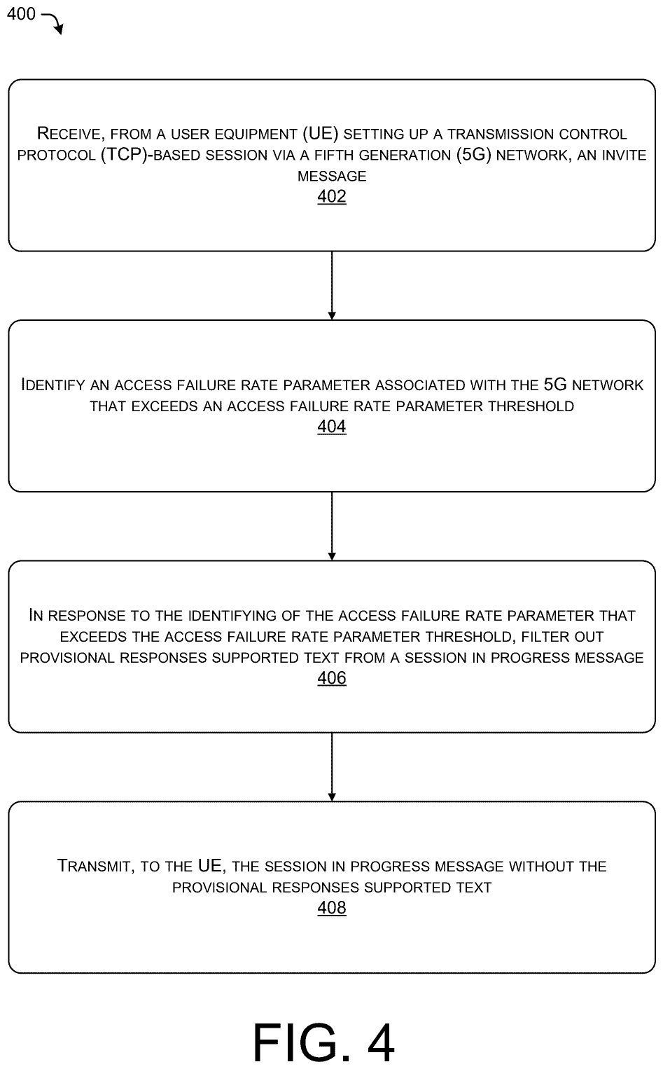

FIG. 4 illustrates an example process 400 for session in progress communication-oriented filtering management. The process 400 may be implemented by a P-CSCF, such as the P-CSCF 128 of FIG. 1. The process 400 is described, by way of example, with reference to the previous figures.

At 402, the P-CSCF 128 can receive, from a UE setting up a TCP-based session via a 5G network, an invite message. For example, the UE, such as the UE 102, may be setting up the TCP-based session via the 5G network. The UE 102 may be compatible with a non-5G network, such as an LTE network, but not the 5G network. The invite message can include an invite SIP message 208.

At 404, the P-CSCF 128 can identify an access failure rate parameter associated with the 5G network that exceeds an access failure rate parameter threshold. The access failure rate parameter may include a percentage of answered telephone calls with respect to a total call volume of the 5G network and/or one or more non-5G networks (e.g., the LTE network).

At 406, the P-CSCF 128 can, in response to the identifying of the access failure rate parameter that exceeds the access failure rate parameter threshold, filtering out provisional responses supported text from a header of a session in progress message. For example, the P-CSCF 128 can receive the session in progress message (e.g., a SIP 183 message 212) with the provisional responses supported tag (e.g., a 100REL tag), and transmit the SIP 183 message 216 without the 100REL tag.

At 408, the P-CSCF 128 can transmit, to the UE 102, the session in progress message 216 without the provisional responses supported tag. For example, the P-CSCF 128 can extract the 100REL tag from the SIP 183 message 212 being routed, to the UE 102 as the SIP 183 message 216 (e.g., without the 100REL tag).

Because the compatibility of the UE 102 may include the non-5G network, but not the 5G network, a fallback for the UE 102 may be performed via the 5G network and/or the LTE network. The fallback may enable the UE 102 to operate utilizing the LTE network. The UE 102 not being compatible with the 5G network may include the UE 102 not being compatible with 5G NR.

Because the UE 102, in response to the receiving of the SIP 183 without the 100REL tag, does not transmit the provisional acknowledgement message and wait for the acknowledgement message, a likelihood of a dropped call associated with the UE 102 while a fallback is being performed for the UE 102 (e.g., attempting to set up a reliable transmission control protocol-based session, such as the TCP protocol-based session, according to which the 100REL tab is inserted in the SIP 183 212) is reduced.

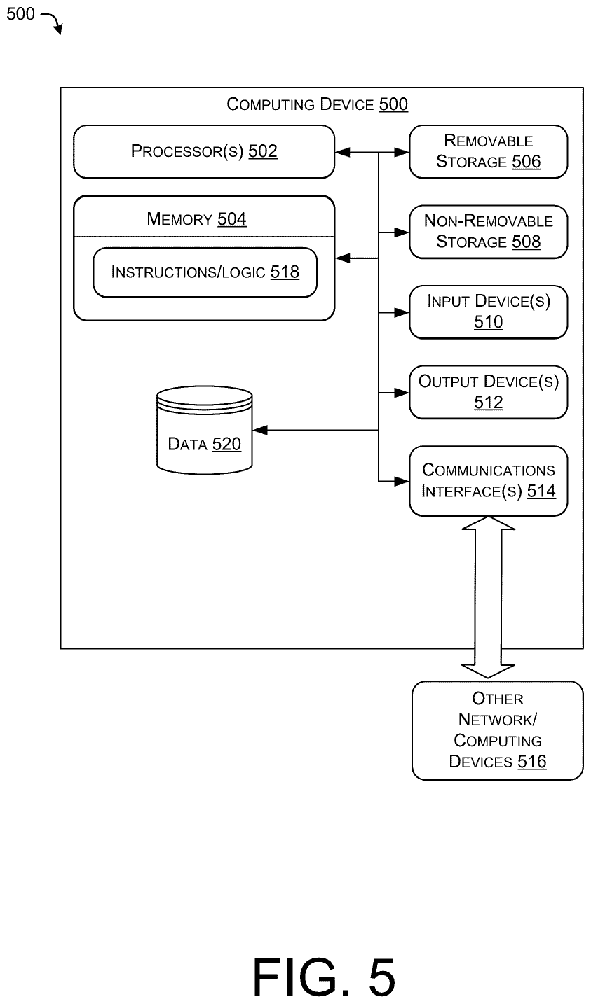

FIG. 5 illustrates is a block diagram of a server computer 500 architecture, in accordance with some examples of the present disclosure. The server computer 500 may be representative of an individual node (or network element) (e.g., a node of the network environment 100, such as the P-CSCF 128, as discussed above with reference to FIG. 1) or multiple nodes (or network elements) (e.g., multiple nodes of the network environment 100) of the cellular network.

As shown, the server computer 500 may include one or more processors 502 and one or more forms of computer-readable memory 504. The server computer 500 may also include additional storage devices. Such additional storage may include removable storage 506 and/or non-removable storage 508.

The server computer 500 may further include input devices 510 (e.g., a touch screen, keypad, keyboard, mouse, pointer, microphone, etc.) and output devices 512 (e.g., a display, printer, speaker, etc.) communicatively coupled to the processor(s) 502 and the computer-readable memory 504. The server computer 500 may further include communications interface(s) 514 that allow the server computer 500 to communicate with other computing devices 516 (e.g., other nodes, a UE(s), etc.) such as via a network. The communications interface(s) 514 may facilitate transmitting and receiving wired and/or wireless signals over any suitable communications/data technology, standard, or protocol, as described herein.

In various embodiments, the computer-readable memory 504 comprises non-transitory computer-readable memory 504 that generally includes both volatile memory and non-volatile memory (e.g., random access memory (RAM), read-only memory (ROM), erasable programmable read-only memory (EEPROM), Flash Memory, miniature hard drive, memory card, optical storage, magnetic cassettes, magnetic tape, magnetic disk storage or other magnetic storage devices, or any other medium). The computer-readable memory 504 may also be described as computer storage media and may include volatile and nonvolatile, removable and non-removable media implemented in any method or technology for storage of information, such as computer readable instructions, data structures, program modules, or other data. Computer-readable memory 504, removable storage 506 and non-removable storage 508 are all examples of non-transitory computer-readable storage media. Computer-readable storage media include, but are not limited to, RAM, ROM, EEPROM, flash memory or other memory technology, compact disc read-only memory (CD-ROM), digital versatile disks (DVD) or other optical storage, magnetic cassettes, magnetic tape, magnetic disk storage or other magnetic storage devices, or any other medium which can be used to store the desired information and which can be accessed by the server computer 500. Any such computer-readable storage media may be part of the server computer 500.

The memory 504 can include logic 518 (i.e., computer-executable instructions that, when executed, by the processor(s) 502, perform the various acts and/or processes disclosed herein) to implement synchronization of subscriber data, according to various examples as discussed herein. For example, the logic 518 is configured to carry out signaling and/or communications associated with and the UE(s) 102, the network nodes (e.g., the HSS 114, the SGW 116, the MGCF 118, the MRF 122, the S-CSCF 124, the I-CSCF 126, and/or the P-CSCF 128, as discussed herein). The memory 504 can further be used to store data 520, which may be used to implement synchronization of subscriber data, as discussed herein. In one example, the data 520 may include network information (e.g., the network information, as discussed above with reference to FIG. 1) and/or mobile device information (e.g., the mobile device information, as discussed above with reference to FIG. 1).

The environment and individual elements described herein may of course include many other logical, programmatic, and physical components, of which those shown in the accompanying figures are merely examples that are related to the discussion herein.

The various techniques described herein are assumed in the given examples to be implemented in the general context of computer-executable instructions or software, such as program modules, that are stored in computer-readable storage and executed by the processor(s) of one or more computers or other devices such as those illustrated in the figures. Generally, program modules include routines, programs, objects, components, data structures, etc., and define operating logic for performing particular tasks or implement particular abstract data types.

Other architectures can be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software can be stored and distributed in various ways and using different means, and the particular software storage and execution configurations described above can be varied in many different ways. Thus, software implementing the techniques described above can be distributed on various types of computer-readable media, not limited to the forms of memory that are specifically described.

What is claimed is:

1. A method comprising:
receiving, by a proxy call session control function (P-CSCF) server and from a non-fifth generation (5G) compatible user equipment (UE) setting up a transmission control protocol (TCP)-based session via a fifth generation (5G) network, an invite session internet protocol (SIP) message;
receiving, by the P-CSCF, a session in progress SIP message;
identifying, by the P-CSCF, an access failure rate parameter associated with the 5G network that exceeds an access failure rate parameter threshold;
in response to the receiving of the session in progress SIP message and the identifying of the access failure rate parameter that exceeds the access failure rate parameter threshold, filtering out, by the P-CSCF, provisional responses supported tag from a header of the session in progress SIP message; and
in response to the filtering out of the provisional responses supported tag, transmitting, by the P-CSCF and to the UE, the session in progress SIP message.

2. The method of claim 1, wherein filtering out the provisional responses supported tag comprises extracting the provisional responses supported tag from the header.

3. The method of claim 1, wherein the UE, not being triggered by the provisional responses supported tag, refrains from transmitting a provisional acknowledgement SIP message and waiting until an acknowledgment SIP message is received as the UE is being redirected to a non-5G network.

4. The method of claim 1, the invite SIP message being associated with a SIP session further comprising:
receiving a previous SIP invite message associated with a previous SIP session; and
forwarding, to the UE, the previous invite SIP message with the provisional responses supported tag, the UE being triggered by the provisional responses supported tag to transmit a provisional acknowledgement SIP message and wait until an acknowledgement SIP message is received.

5. The method of claim 1, where the filtering out of the provisional responses supported tag temporarily converts a portion of communications associated with a transmission protocol comprising TCP from a reliable transmission protocol to unreliable transmission protocol-related communications.

6. The method of claim 1, further comprising:
inserting the provisional responses supported tag in a ringing status message; and
transmitting the ringing status message to the UE.

7. A system, comprising:
at least one processor; and
memory storing instructions that, when executed by the at least one processor, cause the at least one processor to perform operations comprising:
receiving, from a user equipment (UE) setting up a transmission control protocol (TCP)-based session via a fifth generation (5G) network, an invite message;
identifying an access failure rate parameter associated with the 5G network that exceeds an access failure rate parameter threshold;
in response to the identifying of the access failure rate parameter that exceeds the access failure rate parameter threshold, filtering out provisional responses supported text from a session in progress message; and
transmitting, to the UE, the session in progress message without the provisional responses supported text.

8. The system of claim 7, the operations further comprising:
receiving a session in progress message,
wherein transmitting the session in progress message comprises:
in response to the receiving of a session in progress message and the filtering out of the provisional responses supported text, transmitting, to the UE, the session in progress message.

9. The system of claim 7, wherein transmitting the session in progress message comprises:
prior to the transmitting and in response to the identifying of the access failure rate parameter that exceeds the access failure rate parameter threshold, extracting the provisional responses supported text from a header of the session in progress message.

10. The system of claim 7, wherein the UE, not being triggered by the provisional responses supported text, refrains from transmitting a provisional acknowledgement session internet protocol (SIP) message and waiting until an acknowledgment SIP message is received as the UE is being redirected to a non-5G network.

11. The system of claim 7, the invite message comprising a session internet protocol (SIP) invite message associated with a SIP session, the operations further comprising:
receiving a previous SIP invite message associated with a previous SIP session; and
forwarding, to the UE, the previous invite SIP message with the provisional responses supported text, the UE being triggered by the provisional responses supported text to transmit a provisional acknowledgement SIP message and wait until an acknowledgement SIP message is received.

12. The system of claim 7, where the filtering out of the provisional responses supported text temporarily converts a portion of communications associated with a transmission protocol comprising TCP from a reliable transmission protocol to unreliable transmission protocol-related communications.

13. The system of claim 7, further comprising:
inserting the provisional responses supported text in a ringing status message; and
transmitting the ringing status message to the UE.

14. The system of claim 7, wherein the UE is not compatible with 5G new radio (NR).

15. The system of claim 7, wherein the filtering comprises filtering out the provisional responses supported text from a header of the session in progress message.

16. A server, comprising:
at least one processor; and
memory storing instructions that, when executed by the at least one processor, cause the at least one processor to perform operations comprising:
receiving, from a user equipment (UE) setting up a transmission control protocol (TCP)-based session via a fifth generation (5G) network, an invite message;
identifying an access failure rate parameter associated with the 5G network that exceeds an access failure rate parameter threshold; and
in response to the identifying of the access failure rate parameter that exceeds the access failure rate parameter threshold, transmitting, to the UE, a session in progress message without provisional responses supported text.

17. The server of claim 16, the operations further comprising:
receiving the session in progress message; and
prior to the transmitting and in response to the receiving of the session in progress message and the identifying of the access failure rate parameter that exceeds the access failure rate parameter threshold, filtering out the provisional responses supported text from a header of the session in progress message.

18. The server of claim 16, the operations further comprising:
prior to the transmitting and in response to the identifying of the access failure rate parameter that exceeds the access failure rate parameter threshold, filtering out the provisional responses supported text from the session in progress message.

19. The server of claim 16, wherein the UE, not being triggered by the provisional responses supported text, refrains from transmitting a provisional acknowledgement session internet protocol (SIP) message and waiting until an acknowledgment SIP message is received as the UE is being redirected to a non-5G network.

20. The server of claim 16, the invite message comprising a session internet protocol (SIP) invite message associated with a SIP session, the operations further comprising:
receiving a previous SIP invite message associated with a previous SIP session; and
forwarding, to the UE, the previous invite SIP message with the provisional responses supported text, the UE being triggered by the provisional responses supported text to transmit a provisional acknowledgement SIP message and wait until an acknowledgement SIP message is received.
